(19) United States
(12) Patent Application Publication
(10) Pub. No.: US 2004/0090858 A1
(43) Pub. Date: May 13, 2004

(54) Apparatus and method for deaerating and degassing mixtures

(75) Inventor: Harry Katzarov, Stevenson Ranch, CA (US)

Correspondence Address: GREENBERG TRAURIG LLP, 2450 COLORADO AVENUE, SUITE 400E, SANTA MONICA, CA, 90404, US

(73) Assignee: Gruber Systems, Inc.

(21) Appl. No.: 10/293,174

(22) Filed: Nov. 12, 2002

(51) Int. Cl. B29B 7/84

(52) U.S. Cl. 366/75; 366/90; 366/143

(57) ABSTRACT

Apparatus and method for deaerating and degassing of multi-component mixtures, such as polymers, accelerators, catalysts, fillers, color mixtures, and others in a continuously operating process. The configuration of the auger and flights thereon transporting the mixture through the apparatus and the inner configuration of the housing improve the mixing of the materials resulting in a homogenized cast polymer mixture.

### BACKGROUND OF THE INVENTION

1. Field of the Invention

The invention relates to degassing and deaerating devices; and particularly to apparatus and method for deaerating and degassing multi-component mixtures, such as polymers, fillers and catalysts.

2. Related Art

It is known that, in the mixing of certain liquids, such as polymers, fillers, coloring agents, etc. that large amounts of gases, such as air bubbles, are generated in the mixing process. Air may be trapped in some raw material ingredients. Undesirable gases or air must thus be removed during mixing.

One device for continuously degassing such mixtures is disclosed in U.S. Pat. No. 5,024,531 to Will. Another continuous vacuum processor is disclosed in U.S. Pat. No. 6,076,954 to Gisko. There is a need for such apparatus and method which improves the final mixture of polymers and other materials, such as fillers, removing essentially all air therefrom. Such a product would have physical properties that gives the final product a consistency that is better and easier to handle. Degassing has multiple benefits: Mixture improvement during processing, more complete mixing, possibility of ingredient percentages changing, greater range of process operation limits (perhaps ambient temperature or pressure). In addition, it is expected that there are additional end product benefits: Improved strength, life, color, texture, application, or other.

### SUMMARY OF THE INVENTION

It is an object of this invention to provide apparatus and method for deaerating and degassing multi-component mixtures, such as polymers, fillers, etc. to provide an air free final product.

It is still further an object of this invention to carry out the foregoing object resulting in a product that is of better consistency than final products using other degassing and deaerating systems and that is easier to handle.

These and other objects are preferably accomplished by providing apparatus for deaerating and degassing multi-component mixtures, such as polymers, accelerators, catalysts, fillers, color mixtures, and others in a continuously operating process. The configuration of the auger and flights thereon transporting the mixture through the apparatus and the inner configuration of the housing improve the mixing of the materials resulting in a homogenized cast polymer mixture.

### BRIEF DESCRIPTION OF THE DRAWINGS

FIG. 1 of the drawing is a cross-sectional view of the interior of the apparatus for carrying out the teachings of the invention; and

FIG. 2 is a detailed cross-sectional view of a portion of the apparatus of FIG. 1 illustrating mixing of the components.

### DETAILED DESCRIPTION OF THE PREFERRED EMBODIMENTS

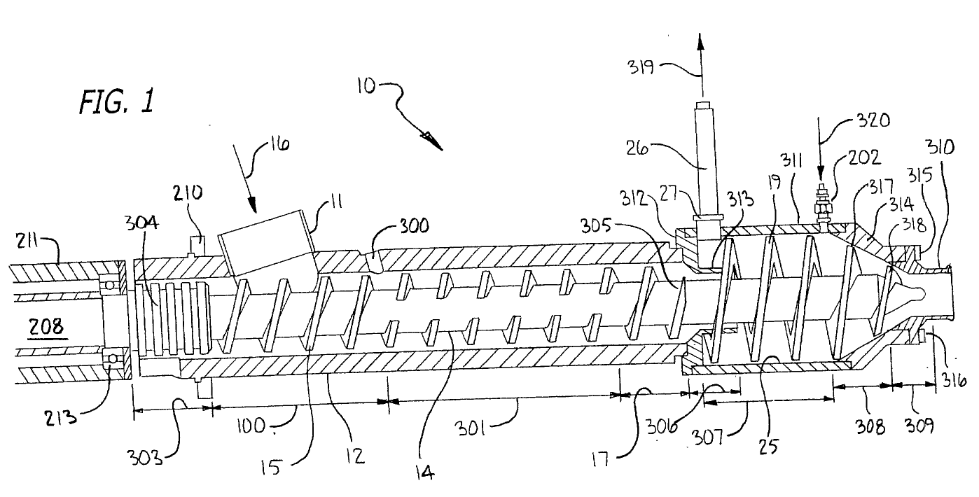

Referring now to FIG. 1 of the drawing, a coaxial multi-compartmented apparatus 10 is shown for deaerating and degassing a multi-component mixture. In the preferred embodiment of the invention, an inlet 11 is provided leading into a hollow gas tight cylindrical housing 12. The solid ingredients of a multi-component mixture is fed therein from a feeder (not shown) as indicated by arrow 16 while any liquids required are fed into housing 12 through liquid inlet 300. Such mixture may include polymers, accelerators, catalysts, fillers, coloring agents, etc. and is fed into inlet 11 in a continuously operated process. Optionally, the mixture may be made in batches in a machine or even manually mixed in a container. The mixture thus enters the feeding chamber portion 100 of housing 12.

An auger 14 is provided having a plurality of integrally connected spaced flights 15 for conveying the mixture from feeding chamber 100 to mixing chamber 301. Auger 14 is rotated by a shaft 208 coupled to auger 14 in any suitable manner. Shaft 208 is mounted in bearing housing 211 rotating about one or more spaced bearing members 212, at opposite ends of housing 211 (only one member 213 shown in FIG. 1). A motor (not shown) is adapted to rotate shaft 208 thus rotating auger 14. Auger 14 is rotated in one direction only by the motor. This forms the driving portion of apparatus 10. A dust seal portion 303 is provided between the driving portion and feeding area 100. A flange 210 encircles housing 12. The shaft portion 204 between shaft 208 and auger 14 may be stepped as shown. Flights 15 are of generally the same diameter within housing 12 within pressurizing chamber 17 of housing 12.

That is, flights 15 are generally the same diameter within the feeding and mixing chambers 100, 301, then terminate in flight 305 at the terminal end of the pressurizing chamber 17. Also, as seen, pressurizing chamber 17 leads into a sealing chamber 306 which in turn fluidly communicates with a vacuumizing chamber 307 leading into a second pressurizing chamber 308 which fluidly communicates with a final sealing chamber 309 at the exit nozzle 310 of apparatus 10.

The sealing, vacuumizing, pressurizing, and sealing chambers 306, 307, 308 and 309 are encompassed within housing 311 coupled to housing 12 by a resilient seal 312 which has a cylindrical portion 313 encircling the shaft of auger 12 within sealing chamber 306. Housing 311 includes an integral tapered portion 314 tapering toward exit nozzle 310. Exit nozzle 310 may also be of a resilient material and secured to tapered portion 314 by spaced nuts 315, 316. Flights 19 within the sealing and vacuumizing chambers of 306, 307 are of a diameter conforming to the inner wall 25 of housing 311 which tapers to exit nozzle 310. Flights 317, 318 are progressively lesser in outer diameter than flights 19 as shown thus providing pumping flights for apparatus 10.

A vacuum line 26 is provided coupled to bushing 27 in fluid communication with the interior of sealing chamber 306. Hose 26 is adapted to be coupled at top to a suitable vacuum source (not shown) as indicated by arrow 319. This hose 26 may be controlled by a conventional solenoid valve (not shown) and may be clear or transparent to view the interior thereof to observe the liquid flowing therethrough.

The vacuum line 26 communicates with sealing chamber 306 where gases collect and are removed out of line 26.

A liquid inlet seal is provided at seal 312 leading into sealing chamber 306. A liquid seal is also provided at the inner wall of exit nozzle 310 by seal 310. The rear facing tapered portions of the flights act as mechanical wipers cleaning the various chambers and ports.

A catalyst injector 202 may optionally be provided in fluid communication with vacuumizing chamber 307. Injector 202 may be coupled to a tee connection fluidly coupled to a pair of air actuated toggle valves fluidly connected to and controlled by solenoid valves for controlling the same as is well known in the art. Flow control valves may also be used for controlling flow therethrough. Thus, a suitable catalyst may be injected into chamber 307 via injector 202 as indicated by arrow 320.

In operation, a mixture of liquids and solids, such as polymers, binding agents, coloring agents, catalyst, air or gasses, and fillers is fed into housing 12 via inlets 11 and 300 which inlets are in gas tight connection with the interior of housing 12. This mixture may be premixed, if desired. The mixture may be fed therein in a continuous or batch feed or even fed in manually, if desired.

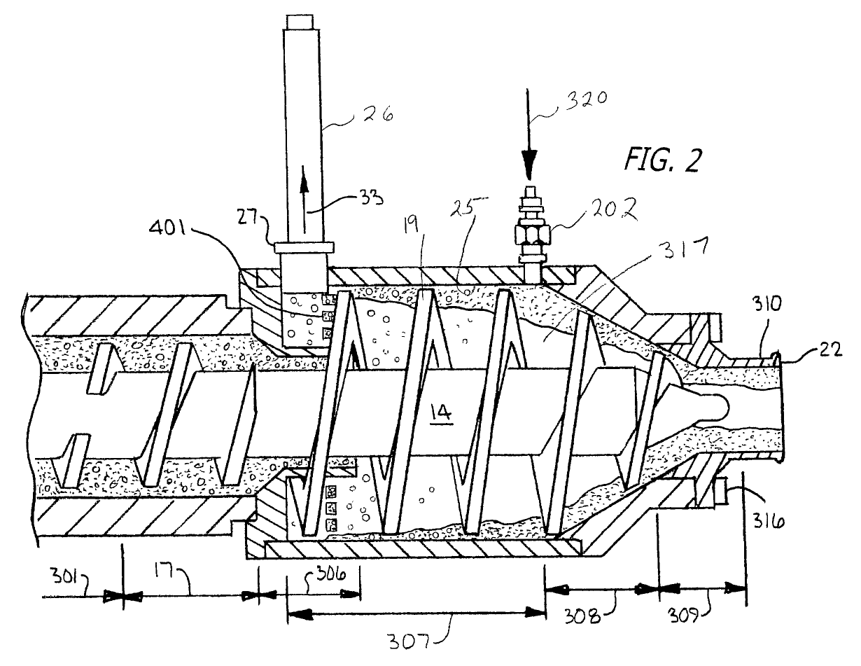

The mixture enters into the feeding chamber 100 of chamber 10 and is fed by rotation of auger 14 to mixing chamber 301. That is, the central core or auger 14 rotates and the rotation speed may be varied to control varying mixing conditions. The mixture goes from the mixing chamber 301, to the pressurizing chamber 17 and into the sealing chamber 306 (see FIG. 2). Air and vapors or gases are eliminated continuously up and out of line 26 to a suitable source.

Vacuumizing chamber 307, which includes the sealing chamber 306, slices the mixture flowing therethrough and the sliced mixture (see slices 401) releases air up and out tube 26 forming a space 317 within the vacuumizing chamber 307, the deaerated material flowing against the inner wall 25 of vacuumizing chamber 307, upon action of flights 19, thus forcing the material to exit nozzle 310.

The finished product is completely mixed in a homogeneous manner. Air is removed out of tube 26 and the finished product has improved physical properties making it better and easier to handle. The process disclosed herein can be used to deaerate and degas any suitable multi-component mixture such as polymers, accelerators, catalysts, fillers, coloring agents, and others in a continuously operating process.

The auger 14 has unique tapered flights leading into and out of the vacuumizing chamber 307 that assists in transporting the mixture and, after degassing and deaerating the mixture, discharging out of the discharge outlet 310. As seen in the drawing, the outer periphery of the flights conform to the configuration of the inner wall of housings 12 and 311. The apparatus in the drawing can be quickly and easily attached to preexisting equipment, such as a motor for rotating auger 14, a feeder for introducing solids and liquids into inlets 11, 300, a vacuum source coupled to tube 26 and a container pipe or other storage means coupled to outlet 310. The apparatus can be easily cleaned.

The low pressure of vacuumizing chamber 307 provides an area for collecting gases and vapors generated during the mixture process for removal from the apparatus 10. The observation tube 26 can be used to inspect visually the interior thereof to watch the process taking place. The flights pump the material out of outlet 310. A liquid seal is provided in sealing chamber 306 by seal 312 and, at sealing chamber 309 provided by resilient exit outlet 310 to maintain a gas tight seal. The flights act as a wipers to clean the interior of the vacuumizing chamber 307.

The motor (not shown) for rotating auger 14 may be a variable speed motor. The pitch of the flights are selected to provide a narrow pitch in the feeding and mixing chambers 100 for receiving the dry material filler, resin, and the like, and mixing the same while transporting the mixture into the vacuumizing chamber 307. Here, the pitch of the flights is relatively wide to deaerate and degas the mixture and remove voids formed in the material and out of outlet 310 due to the vacuum control. The resulting degassed and deaerated mixture is moved over tapered portions of the flights of auger 14 and pushed via the flights out of nozzle 310.

In summary, apparatus 10 has an ingredient feeding chamber 100, a mixing chamber 301, a pressurized area or chamber 17, a sealing chamber 306, a vacuumizing chamber 307, and an additional pressurized outlet area or chamber 308 terminating in a sealed area or chamber 309.

The coaxial mixer auger 14 rotates and ingredients are introduced into the mixing section of the apparatus 10, and are blended together, under ambient pressure conditions. This may include entrained air. The mixing auger 14 blends, conveys and pumps the ingredients. Ingredients are moved forward by the auger 14 to a higher pressure area. Pressure is created by the rotating auger action.

As the ingredients are moved forward, the pressure increases. A flow restriction is positioned at the end of the auger 14 between pressurizing chamber 17 and sealing chamber 306. Material is pumped through the annular orifice and into the next chamber 307. The material is expanded into the chamber 307. The annular orifice is also a liquid seal 312, which seals the vacuum into the vacuum chamber 307. The vacuum chamber 307 is in communication with a vacuum source (not shown) via tube 26.

As discussed above with respect to FIG. 2, the material in vacuum chamber 307 is centrifugally spread, through a “slinging” action, to the perimeter of the auger 14, and spread across the face of the vacuum chamber 307 inner diameter in a thin layer, and sheared repeatedly, mechanically, as seen in slices 401, to release entrained air, or other gas bubbles. When these bubbles are mechanically released from the mixture, they migrate to the low pressure zone created by the communication with the vacuum source. This action removes air or gas from the mixture and chamber 307. A mechanical vacuum seal (FIG. 1) is provided between seal 312 and the beginning of the tapered portion 314.

The auger 14 gathers up the mixture spread on the inner diameter of the vacuum chamber 307, and begins to convey, and pump the mixture forward into another higher pressure area 308 at the discharge zone. Pressure gradient in this chamber 308 is from high vacuum (vacuum source inlet 26) to high pressure (material outlet 310). At the high pressure area, another liquid seal keeps the ambient pressure out of the chamber 307. At the vacuum source a mechanical wiping action by the flights prevents clogging of the vacuum source port 26.

Although various modifications may be suggested by one skilled in the art, the scope of this invention should only be limited by the scope of the appended claims

While the specification describes particular embodiments of the present invention, those of ordinary skill can devise variations of the present invention without departing from the inventive concept.

I claim:

1. Apparatus for continuous degassing and deaerating of a mixture of liquids and solids, such as polymer binding agents and fillers, said apparatus comprising:
mixture inlet means in a fluid tight manner to a housing, said housing having an elongated hollow interior;
an elongated mixing auger extending through said interior, said inlet means being in fluid communication with said auger forming a feeding chamber in said interior;
a mixing chamber in said housing disposed between said feeding chamber and a vacuumizing chamber within said housing, said auger having a plurality of spaced flights of a diameter generally related to the inner diameter of said feeding and mixing chambers and tapered forwardly toward said vacuumizing chamber;
said auger having said flights within said feeding and mixing chamber fixed thereto for rotation therewith, the entrance leading into said vacuumizing chamber from said mixing chamber being a reduced neck portion of lesser diameter than the diameter of said mixing chamber forming a first feeding chamber, said vacuumizing chamber within said housing being substantially greater in diameter than the diameter of said mixing and feeding chambers and said neck portion leading therein, said vacuumizing chamber having an inner wall tapering downwardly and away from said vacuumizing chamber to a pressurizing chamber terminating in an exit outlet;
said flights within said vacuumizing chamber being substantially greater in diameter than said flights in said feeding and mixing chambers and conforming generally to the inner configuration of said vacuumizing chamber, said flights within said pressurizing chamber being substantially lesser in outer diameter than said flights within said vacuumizing chamber; and
vacuum means in fluid communication with the interior of said vacuumizing, chamber for removing gases and vapors from said vacuumizing chamber and eliminating voids in said mixture flowing therethrough.

2. The apparatus of claim 1 wherein said vacuum means includes a transparent observation tube for viewing the interior thereof.

3. The apparatus of claim 1 including a catalyst inlet communicating with the interior of said vacuumizing chamber.

4. The apparatus of claim 1 wherein said exit outlet terminates in a resilient nozzle having a reduced neck portion forming a sealing chamber.

5. The apparatus of claim 4 wherein a liquid seal is provided at said exit outlet and at said first sealing chamber.

6. The apparatus of claim 1 wherein said mixture inlet means includes a first solids inlet and a second liquid inlet.

7. A method for degassing and deaerating a multi-component mixture, such as polymers, fillers, catalysts, etc. comprising the steps of:
providing an elongated hollow housing having an auger having a plurality of spaced flights thereon extending through said housing with at least one inlet leading into said housing and an outlet leading out of said housing;
feeding a multi-component mixture into said at least one inlet and conveying said mixture through a first mixing chamber in said housing, providing a first pitch of said flights within said mixing chamber tapered forwardly toward said outlet and of a first diameter generally related to the inner diameter of said mixing chamber;
providing a vacuumizing chamber within said housing between said inlet and said outlet having an inner diameter substantially greater than the inner diameter of said mixing chamber with said vacuumizing chamber tapering downwardly toward said outlet,
providing the pitch of said flights within said vacuumizing chamber tapering toward said outlet and of an outer diameter related to the inner diameter of said vacuumizing chamber;
providing an inlet within said housing leading from said mixing chamber through a reduced neck portion into said vacuumizing chamber, said auger passing therethrough; and
providing a vacuum source connected to said housing in fluid communication with said vacuumizing chamber for removing gases and vapors therefrom.

8. The method of claim 7 wherein the step of feeding a mixture includes the step of separating feeding solids and liquids into said housing.

9. The method of claim 7 including the step of feeding a catalyst into said vacuumizing chamber.

10. The method of claim 7 including the step of pressurizing said mixture between said vacuumizing chamber and said outlet.
